(19) United States
(12) Patent Application Publication
(10) Pub. No.: US 2012/0195287 A1
(43) Pub. Date: Aug. 2, 2012

(54) COMMUNICATION METHOD USING DUPLICATED ACKNOWLEDGEMENT

(75) Inventors: Jung Soo Jung, Seongnam-si (KR); Jang Won Lee, Seoul (KR); Byung Gook Kim, Seoul (KR); Shin Young Jung, Seoul (KR)

(73) Assignees: Industry-Academic Cooperation Foundation, Yonsei University, Seoul (KR); SAMSUNG ELECTRONICS CO. LTD., Suwon-si (KR)

(21) Appl. No.: 13/359,998

(22) Filed: Jan. 27, 2012

(30) Foreign Application Priority Data
Jan. 28, 2011 (KR) 10- 2011-0008986

(51) Int. Cl. H04W 36/00

(52) U.S. Cl. 370/331

(57) ABSTRACT

Communication methods using duplicated acknowledgement (ACK) are provided. A communication method of a serving base station includes determining if a handover of a device attached to the serving base station is required, and, if the handover is required, transmitting two or more duplicated ACKs to a fixed host. The two or more duplicated ACKs have the same identifier as a final ACK transmitted from the device to the fixed host. This method can alleviate an unnecessary reduction in transmission rate caused by timeout that may occur during handover of the device.

### PRIORITY

This application claims the benefit under 35 U.S.C. §119(a) of a Korean patent application filed on Jan. 28, 2011 in the Korean Intellectual Property Office and assigned Serial No. 10-2011-0008986, the entire disclosure of which is hereby incorporated by reference.

### BACKGROUND OF THE INVENTION

1. Field of the Invention

The present invention relates to communication technology. More particularly, the present invention relates to a communication method for avoiding timeout by transmitting a duplicated acknowledgement (ACK).

2. Description of the Related Art

In the past, only wired communications, such as a wired Local Area Network (LAN), were used for accessing the Internet. However, with recent advances in wireless communication technology, various devices that are capable of wireless communication, such as a notebook computer or a mobile phone, have been widely used. Accordingly, as the use of data communication based on such devices and the Internet is rapidly increasing, the operation and performance maintenance of Transmission Control Protocol (TCP) in wireless links has become an important issue. For example, the use of TCP in wireless devices may cause problems that are different from problems experienced in a wired network. Accordingly, an effective solution may be required.

Handover is a significant cause of packet transmission delay in a wireless link. More particularly, most mobile communication systems are now using or considering a hard handover technology in which a device disconnects its communication with a serving base station and, after handover, establishes communication with a new base station. In this case, if the device detaching time required for disconnecting and resuming a communication is too lengthy, or if data forwarding from a serving base station to a target base station is delayed, transmission of an ACK packet for forwarded data may be delayed and thereby a timeout may occur at a fixed host. However, since such timeout is not caused by congestion in a wired section but caused by a temporary phenomenon in a wireless section, any congestion control may unnecessarily reduce a transmission rate and thereby waste bandwidth.

### BRIEF SUMMARY OF THE INVENTION

Aspects of the present invention are to address at least the above-mentioned problems and/or disadvantages and to provide at least the advantages described below. Accordingly, an aspect of the present invention is to provide a communication method for alleviating an unnecessary reduction in transmission rate caused by timeout that may occur during handover of a device. Another aspect of the present invention is to minimize modification of an existing protocol operation and wireless communication system operation.

According to an aspect of the present invention, a communication method of a serving base station is provided. The method includes determining if a handover of a device attached to the serving base station is required, and if the handover is required, transmitting two or more duplicated acknowledgements (ACKs) to a fixed host wherein the two or more duplicated ACKs have the same identifier as a final ACK transmitted from the device to the fixed host.

According to another aspect of the present invention, a communication method of a device is provided. The method includes attaching to a target base station according to handover, and after the attaching to the target base station, transmitting two or more duplicated ACKs to a fixed host wherein the two or more duplicated ACKs have the same identifier as a final ACK transmitted from the device to the fixed host.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic view illustrating a network configuration of a mobile communication system according to an exemplary embodiment of the present invention.

FIG. 2 is a view illustrating a Transmission Control Protocol (TCP) state of a fixed host using TCP-Reno according to an exemplary embodiment of the present invention.

FIG. 3A is a flowchart illustrating a communication method of a serving base station in accordance with an exemplary embodiment of the present invention.

FIG. 3B is a flowchart illustrating a slow start avoidance step according to an exemplary embodiment of the present invention.

FIG. 4 is a flow diagram illustrating a handover process according to the related art.

FIG. 5 is a flow diagram illustrating a handover process in accordance with an exemplary embodiment of the present invention.

FIG. 6A is a flowchart illustrating a communication process of a device in accordance with an exemplary embodiment of the present invention.

FIG. 6B is a flowchart illustrating a slow start avoidance step according to an exemplary embodiment of the present invention.

FIG. 7 is a flow diagram illustrating a handover process according to the related art.

FIG. 8 is a flow diagram illustrating a communication process in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Transmission Control Protocol (TCP) is a kind of connection-oriented transmission protocol. TCP is widely used as a sub transmission protocol for various application layer protocols such as HyperText Transfer Protocol (HTTP), File Transfer Protocol (FTP), and Simple Mail Transfer Protocol (SMTP). TCP not only provides end-to-end reliable data transmission, but also prevents excessive traffic flows on a link through a congestion control. More particularly, when an acknowledgement (ACK) packet for a TCP packet is not received for a given time and a timeout occurs, a TCP flow control algorithm determines that there is congestion in the middle of path, and rapidly reduces the transmission rate by reducing a window size to one. Additionally, when receiving three or more duplicated ACK packets for a single TCP packet, a congestion window (cwnd) is reduced to half of the current window and fast retransmission is performed.

Since TCP is designed without considering its use in wireless links, a data service using TCP in a wireless device may invite several problems. More particularly, when timeout occurs due to packet loss, packet retransmission, handover in wireless links, or when three duplicated ACKs are received, TCP uses a congestion control technique of the related art. Since such packet low or timeout is not caused by excessive traffic in a wired section, any congestion control may unnecessarily reduce a transmission rate and thereby waste bandwidth.

Various types of techniques have been proposed in order to improve TCP performance in wireless links. One of them is to divide a connection between a Fixed Host (FH) and User Equipment (UE) into a wired section (FH-BS) and a wireless section (BS-UE) at a Base Station (BS) or any middle node. I-TCP, M-TCP, etc. are examples of this type of technique. In this type, the base station stores all packets transmitted to the user equipment from the fixed host, creates a relevant ACK packet, and transmits it to the fixed host in order to alleviate a reduction in transmission rate caused by packet loss and transmission delay in a wireless section. This type may, however, invite another problem since the fixed host and the user equipment may have different information about TCP packet reception. Furthermore, since it is always applied regardless of the occurrence of packet loss or handover, the base station may be required to increase its throughput unnecessarily.

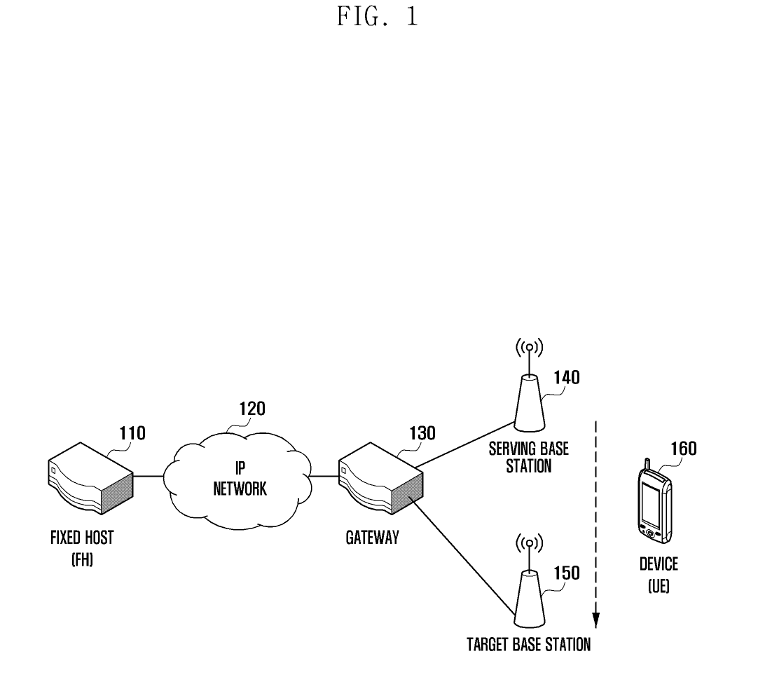

FIG. 1 is a schematic view illustrating a network configuration of a mobile communication system according to an exemplary embodiment of the present invention.

Referring to FIG. 1, the mobile communication system may be used for providing a variety of communication services such as voice, packet data, and the like. The mobile communication system includes a fixed host 110, an Internet Protocol (IP) network 120, a gateway 130, a serving base station 140, a target base station 150, and a device 160.

The device 160 may be fixed or have mobility. The device may be also referred to as User Equipment (UE), a Mobile Station (MS), a User Terminal (UT), a Subscriber Station (SS), a wireless device, and the like. The base stations 140 and 150 are fixed stations that communicate with the device 160, and may be also referred to as evolved Node B (eNB), a Base Transceiver System (BTS), an Access Point (AP), and the like.

Although not illustrated, the base stations 140 and 150 are connected to an Evolved Packet Core (EPC) through a proper interface defined in each mobile communication system standard. The fixed host 110 is connected to the device 160 through the IP network 120 and provides a data service to the device 160. In FIG. 1, the device 160 performs a handover from the serving BS 140 to the target BS 150. The gateway 130 connects the base stations 140 and 150 to the IP network 120 in order to transmit packets and establish paths.

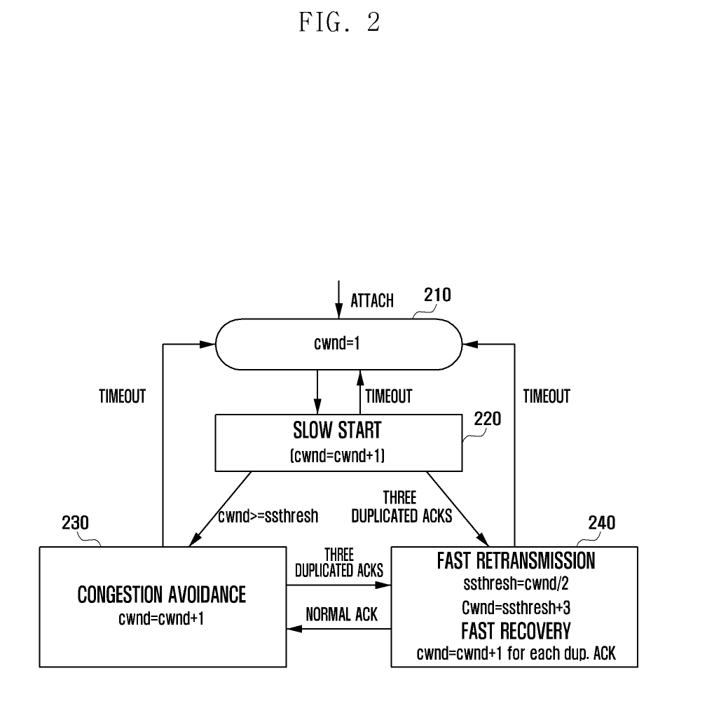

FIG. 2 is a view illustrating a TCP state of a fixed host using TCP-Reno according to an exemplary embodiment of the present invention.

Referring to FIG. 2, when the fixed host 110 starts to transmit TCP layer data to the device 160, the fixed host 110 operates in a slow start state and establishes the cwnd to one in step 210.

In step 220, the fixed host 110 increases the cwnd by one packet unit whenever receiving an ACK packet. In this step, if a cwnd value reaches a predetermined slow-start threshold (ssthresh), the fixed host 110 proceeds to step 230.

In step 230, the fixed host 110 operates in a congestion avoidance state and increases the cwnd by one packet unit whenever receiving an ACK packet. TCP of the fixed host 110 measures the round trip time (t_{RTT}) of the received packet and thereby updates the retransmission timeout (t_{RTO}). In step 220, 230 or 240, if the fixed host 110 fails to receive an ACK packet in response to the transmitted packet within the t_{RTO}, the fixed host 110 determines that congestion occurs in a middle node. The fixed host 110 increases the cwnd by one packet unit, returns to step 210, and operates in a slow start state. On the contrary, when receiving three duplicated ACKs in step 220 or 230, the fixed host 110 proceeds to step 240.

In step 240, the fixed host 110 determines that a relevant packet is lost, reduces the cwnd by half, performs fast retransmission of the packet, and operates in a fast recovery state. Also, whenever further receiving any duplicated packet, the fixed host 110 increases the cwnd by one packet unit and transmits a new packet. If receiving a new normal ACK packet in a fast recovery state in step 240, the fixed host 110 proceeds to step 230 and operates in a congestion avoidance state. As discussed above, in case of packet retransmission caused by a duplicated packet, the fixed host 110 reduces the cwnd by half and rapidly performs retransmission of a packet and transmission of a new packet, unlike a slow start operation caused by timeout, so that any reduction in the TCP data transmission rate may be less severe.

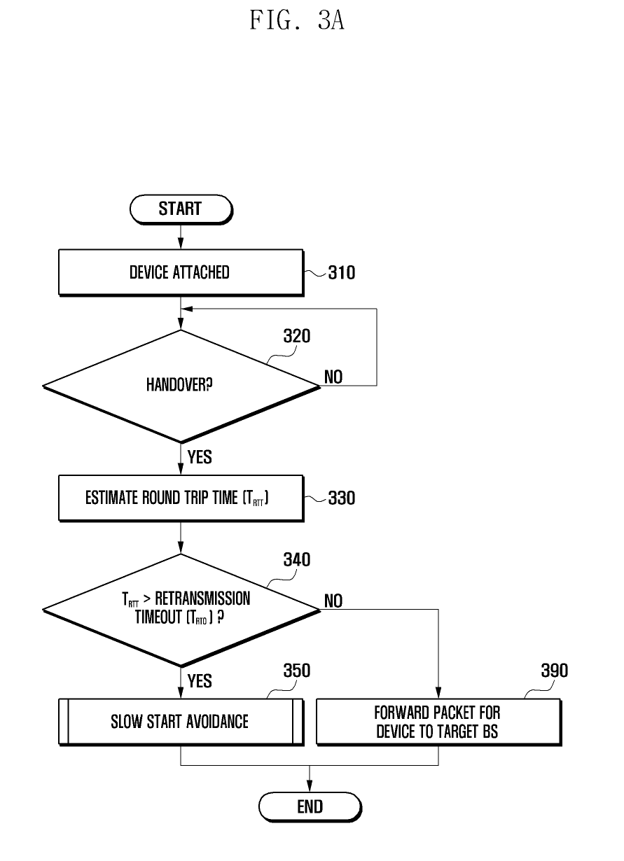

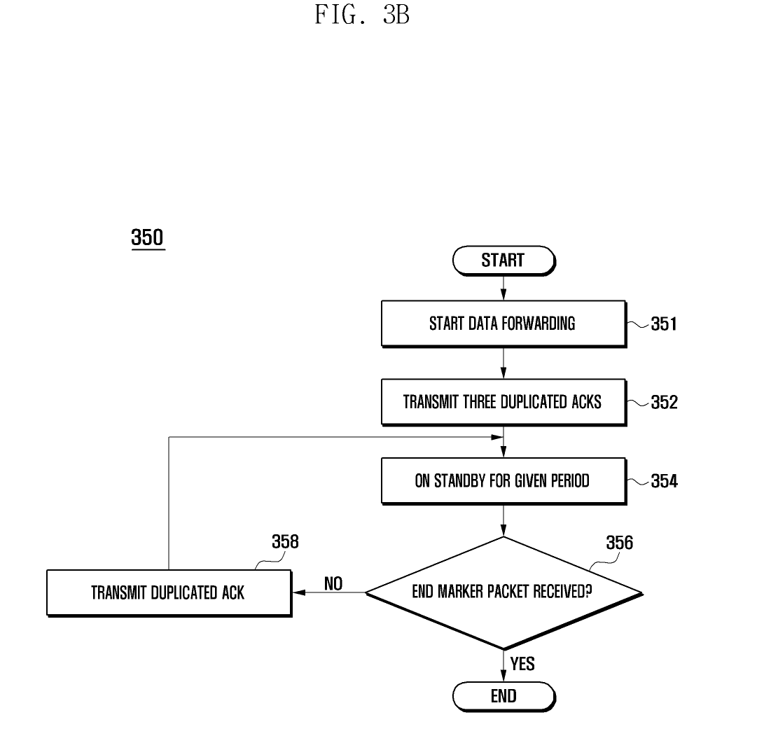

FIG. 3A is a flowchart illustrating a communication method of a serving base station in accordance with an exemplary embodiment of the present invention. As mentioned above in FIG. 1, it is supposed that the device 160 performs a handover from the serving BS 140 to the target BS 150.

Referring to FIG. 3A, a method in which the serving base station 140 predicts the occurrence of a timeout due to device detached time delay and prevents the predicted timeout when the device 160 performs a hard handover between the base stations 140 and 150 is provided. This exemplary method for preventing a timeout includes predicting the occurrence of a timeout in a TCP packet transmitted by the fixed host 110 and forwarded to the target base station 150 through the serving base station 140 when a handover occurs between the base stations 140 and 150, and transmitting a duplicated ACK packet by the serving base station 140 in order to prevent TCP of the fixed host 110 from operating in a slow start state. This exemplary embodiment relates to the operation of the base station 140. A transmission layer of the device 160 and that of the fixed host 110 follow the operation of normal TCP.

In step 310, the device 160 is attached to the serving base station 140.

In step 320, the serving base station 140 determines whether to perform a handover of the device 160. For example, if the strength or quality of a signal of the serving base station 140 received by the device 160 is smaller than a given level, or if the strength or quality of a signal of the target base station 150 is greater by a given level than the strength or quality of a signal of the serving base station 140 received by the device 160, a handover may be determined to be performed. The serving base station 140 may receive a report on signal quality of the target base station 150 from the device 160 periodically or by means of direct instructions. Depending on the received report, the serving base station 140 determines whether to perform a handover of the device 160 and which base station is the target of the handover.

When a handover is performed, the serving base station 140 transmits a handover command message and necessary information for handover to the device 160. The determination of handover is well known in the art, so detailed descriptions will be avoided herein. If no handover is performed, step 320 is repeated until a handover is determined to be performed.

If it is determined in step 320 that a handover is to be performed, the serving base station 140 estimates t_{RTT} of a packet which has been already transmitted to the device 160 and for which ACK is not yet received in step 330. As represented in Equation 1, t_{RTT} may be defined as the sum of the smoothed RTT (t_{SRTT}) of a TCP flow transmitted to the device 160 by the fixed host 110 and the detached time (t_{HO}) of the device 160 due to handover.

t_{RTT}=t_{SRTT}+t_{HO} Equation 1

In a network with no serious congestion, the t_{sRTT} of a flow transmitted to the device 160 from the fixed host 110 may be similar to that of a flow transmitted to the fixed host 110 from the device 160. Therefore, the serving base station 140 may estimate t_{RTT} by using t_{sRTT} of a flow transmitted to the fixed host 110 from the device 160.

The value of t_{HO} of the device 160 due to handover is determined according to types and procedures of handover, so the serving base station 140 may obtain t_{HO} through calculation.

Equation 1 is exemplary only and not to be considered as a limitation of the present invention. Alternatively, any specific invariable may be added or multiplied, or any additional variable may be used to determine t_{RTT}.

In step 340, the serving base station 140 determines whether t_{RTT} estimated in step 330 is greater than t_{RTO}. t_{RTO} may be set to one second which is the minimum value proposed in the relevant TCP standard document RFC 2988. This may be varied according to a TCP design. Exemplary embodiments of the present invention will be fully applied to handover circumstances as t_{RTO} is relatively smaller, and will only be applied to a case of serious TCP delay as t_{RTO} is relatively greater.

If the estimated t_{RTT} is greater than t_{RTO}, a possibility that timeout will occur is increased. Therefore, the fixed host 110 is in danger of operating in a slow start state. In order to prevent this, when it is determined in step 340 that the estimated t_{RTT} is greater than t_{RTO}, the serving base station 140 proceeds to step 350 and performs a slow start avoidance operation. On the contrary, when it is determined in step 340 that the estimated t_{RTT} is smaller than or equal to t_{RTO}, a possibility of timeout is decreased and thereby the fixed host 110 is out of danger of operating in a slow start state. Therefore, in this case, the serving base station 140 proceeds to step 390 and forwards a packet for the device 160 to the target base station 150 according to a process of the related art.

FIG. 3B is a flowchart illustrating a slow start avoidance step according to an exemplary embodiment of the present invention.

Referring to FIG. 3B, the serving base station 140 starts to forward a packet for the device 160 to the target base station 150 according to a process of the related art in step 351.

In step 352, the serving base station 140 transmits, to the fixed host 110, two (or more) duplicated ACKs having the same identifier (e.g., acknowledgement number field) as the final ACK transmitted from the device 160 to the fixed host 110. Therefore, the fixed host 110 receives in total three ACKs (i.e., the final ACK from the device 160 and two ACKs from the serving base station 140) with the same identifier. If three or more duplicated ACKs are received before timeout expiry, the fixed host 110 does not perform an operation in a slow start state (e.g., step 220 shown in FIG. 2). Instead, the fixed host 110 performs fast retransmission and operates in a fast recovery state (e.g., step 240 shown in FIG. 2). Here, the serving base station 140 sends three duplicated ACKs to the fixed host 110 in order to perform fast retransmission more reliably. However, even though the serving base station 140 sends only two duplicated ACKs to the fixed host 110, the present invention may be realized. If the fixed host 110 performs fast retransmission and operates in a fast recovery state only when additionally receiving three or more ACKs with the same identifier as a previously received ACK, the serving base station 140 should send at least three duplicated ACKs to the fixed host 110 such that the fixed host 110 can perform fast retransmission.

In step 354, the serving base station 140 is on standby for a given period. In step 356, the serving base station 140 determines whether an end marker packet is received. When the device 160 is attached to the target base station 150, the gateway 120 transmits the end marker packet to the serving base station 140. Therefore, the serving base station 140 recognizes the completion of handover by receiving the end marker packet. Once receiving the end marker packet, the serving base station 140 stops data forwarding and closes the slow start avoidance. If it is determined in step 356 that the end marker packet is not received, the serving base station 140 resends, to the fixed host 110, a duplicated ACK with the same identifier as the duplicated ACK in step 352. Until the end marker packet is received, the serving base station 140 transmits a duplicated ACK to the fixed host 110 at regular intervals by repeating steps 354, 356 and 358. The fixed host 110 that receives duplicated ACKs can transmit a new packet in a fast recovery state.

Thereafter, the device 160 attached to the target base station 150 receives a packet forwarded from the target base station 150 and transmits a relevant ACK (i.e., normal ACK) to the fixed host 110. If the fixed host 110 is in a fast recovery state (e.g., step 240 shown in FIG. 2), the fixed host 110 operates in a congestion avoidance state (e.g., step 230 shown in FIG. 2) after receiving a normal ACK.

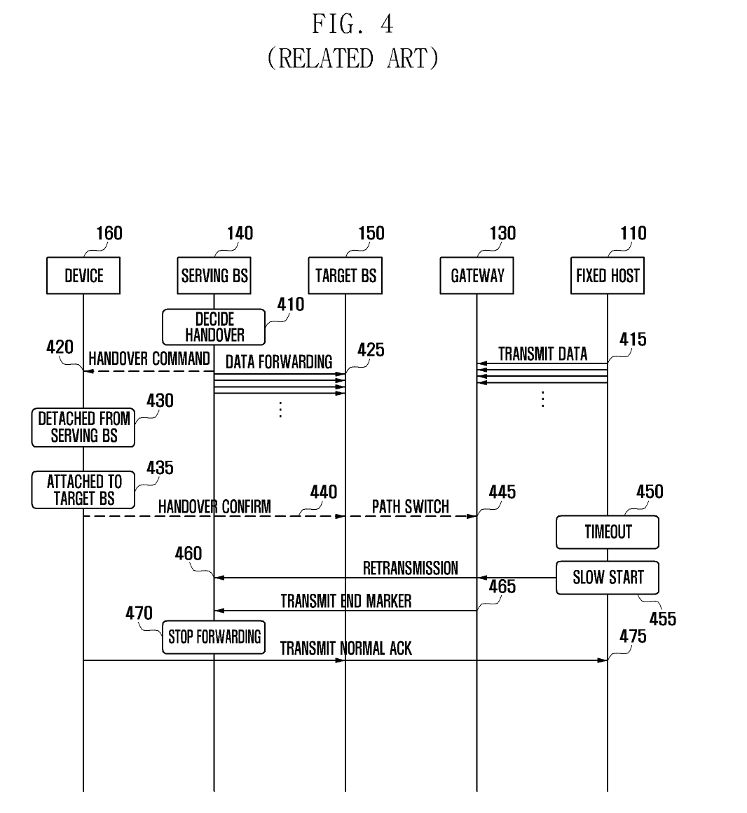

FIG. 4 is a flow diagram illustrating a handover process according to the related art.

Referring to FIG. 4, the serving base station 140 determines if a handover is necessary in step 410. For example, if the strength or quality of a signal of the serving base station 140 received by the device 160 is smaller than a given level, or if the strength or quality of a signal of the target base station 150 is greater by a given level than the strength or quality of a signal of the serving base station 140 received by the device 160, it may be determined that a handover should be performed. For example, the serving base station 140 may receive a report on signal quality of the target base station 150 from the device 160 periodically or by means of direct instructions. Depending on the received report, the serving base station 140 determines whether to perform a handover of the device 160 and which base station is the target of handover. Since the determination of handover is well known in the art, detailed descriptions will be avoided herein.

In step 415, the fixed host 110 transmits data for the device 160 to the gateway 130. Since a handover is not yet completed, the gateway 130 transmits the received data to the serving base station 140. Such data transmission may be performed concurrently with other steps.

In step 420, when a handover is determined to be performed, the serving base station 140 transmits a handover command message and necessary information for handover to the device 160. In step 425, the serving base station 140 forwards a packet for the device 160 to the target base station 150. This data forwarding in step 425 continues until the serving base station 140 recognizes the completion of the handover.

The device 160 is detached from the serving base station 140 in step 430 and attached to the target base station 150 in step 435. In step 440, the device 160 sends a handover confirm message to the target base station 150. In step 445, the target base station 150 that receives the handover confirm message notifies the gateway 130 that the path for the device 160 is changed. Therefore, the gateway 130 can switch path information indicating a path that leads to the device 160.

Due to delays caused by detachment in step 430 and attachment in step 435, the fixed host 110 is subject to timeout in step 450. Also, in step 455, the fixed host 110 operates in a slow start state. As discussed above, in a slow start state, the cwnd becomes one, so that the transmission rate may be considerably reduced. In step 460, through the gateway 130, the fixed host 110 retransmits a specific packet for which ACK is not received.

In step 465, the gateway 130 transmits an end marker indicating the completion of handover to the serving base station 140. In step 470, the serving base station 140 that receives the end marker stops data forwarding. In step 475, the device 160 receives data through the target base station 150 and transmits a normal ACK to the fixed host 110.

According to the exemplary process shown in FIG. 4, the transmission rate is considerably reduced since a slow start operation is performed.

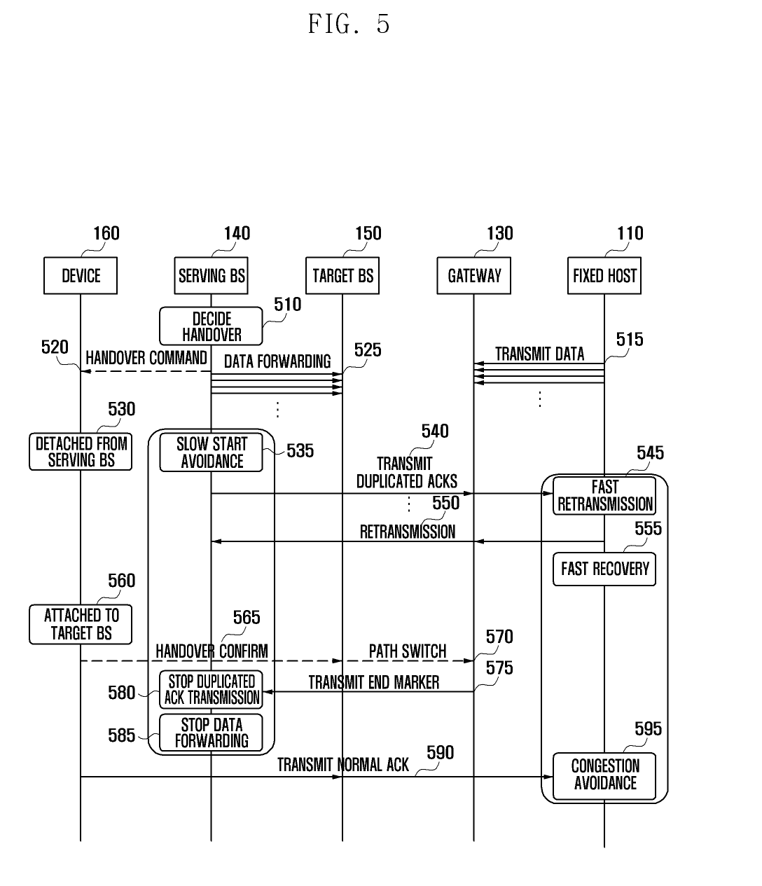

FIG. 5 is a flow diagram illustrating a handover process in accordance with an exemplary embodiment of the present invention.

Referring to FIG. 5, the serving base station 140 determines if a handover is necessary in step 510. For example, if the strength or quality of a signal of the serving base station 140 received by the device 160 is smaller than a given level, or if the strength or quality of a signal of the target base station 150 is greater by a given level than the strength or quality of a signal of the serving base station 140 received by the device 160, it may be determined that a handover should be performed. For example, the serving base station 140 may receive a report on signal quality of the target base station 150 from the device 160 periodically or by means of direct instructions. Depending on the received report, the serving base station 140 determines whether to perform a handover of the device 160 and which base station is the target of handover. Since the determination of handover is well known in the art, detailed descriptions will be avoided herein.

In step 515, the fixed host 110 transmits data for the device 160 to the gateway 130. Since a handover is not yet completed, the gateway 130 transmits the received data to the serving base station 140. Such data transmission may be performed concurrently with other steps.

In step 520, when a handover is determined to be performed, the serving base station 140 transmits a handover command message and necessary information for handover to the device 160. In step 525, the serving base station 140 forwards a packet for the device 160 to the target base station 150. This data forwarding in step 525 continues until the serving base station 140 recognizes the completion of handover.

In step 530, the device 160 that receives the handover command is detached from the serving base station 140. In step 535, the serving base station 140 that sends the handover command performs a slow start avoidance operation. As discussed above with reference to FIGS. 3A and 3B, the slow start avoidance is performed when t_{RTT} is greater than t_{RTO}. In step 540, the serving base station 140 transmits three or more duplicated ACKs to the fixed host 110 in order to prevent a return to a slow start state due to timeout expiry of the fixed host 110. In step 545, the fixed host 110 that receives three or more duplicated ACKs performs a fast retransmission operation. Namely, the fixed host 110 sets up the ssthresh and cwnd as follows: ssthresh=cwnd/2, cwnd=ssthresh+3. In step 550, the fixed host 110 retransmits data that corresponds to a relevant duplicated ACK. In step 555, the fixed host 110 performs a fast recovery operation and thereby increases cwnd by one whenever further receiving a duplicated ACK.

In step 560, the device 160 is attached to the target base station 150. In step 565, the device 160 sends a handover confirm message to the target base station 150. In step 570, the target base station 150 notifies the gateway 130 that information about a path for the device 160 is changed. So, the gateway 130 can switch path information indicating a path that leads to the device 160. In step 575, the gateway 130 transmits an end marker indicating the completion of handover to the serving base station 140. The serving base station 140 that receives the end marker stops periodic transmission of duplicated ACKs in step 580, and, in step 585, stops data forwarding started from step 525.

In step 590, the device 160 receives data through the target base station 150 and transmits a normal ACK to the fixed host 110. In step 595, the fixed host 110 that receives the normal ACK performs a congestion avoidance operation.

Unlike the process shown in FIG. 4, by means of transmission of a duplicated ACK, the fixed host 110 performs a fast retransmission and fast recovery operation, instead of a slow start operation, so that the transmission rate is not reduced as significantly.

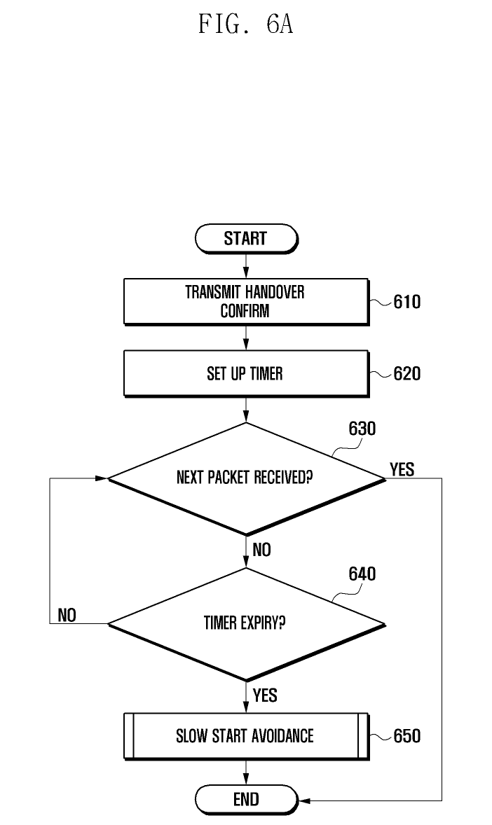

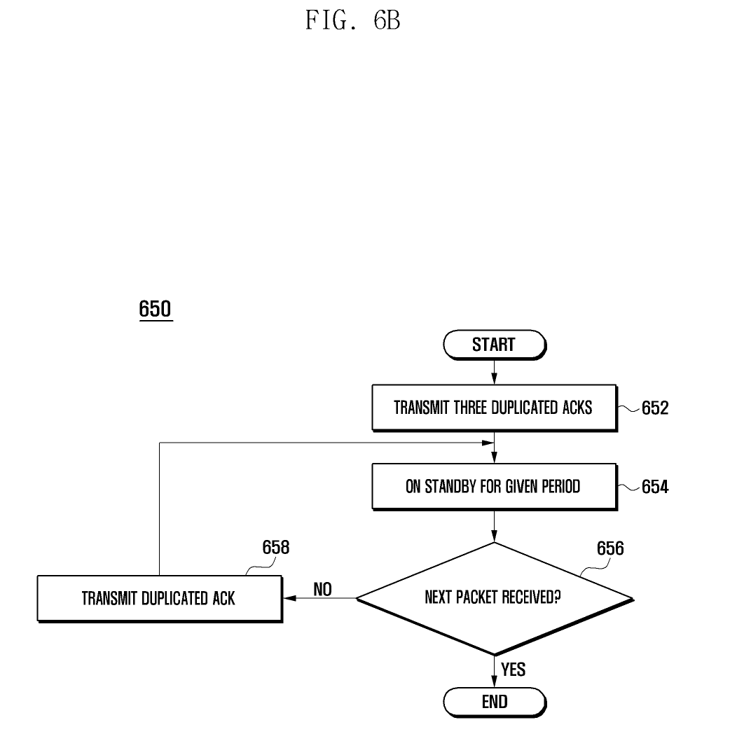

FIG. 6A is a flowchart illustrating a communication process of a device in accordance with an exemplary embodiment of the present invention.

The exemplary embodiment described in FIG. 6A provides a method in which the device 160 predicts the occurrence of a timeout due to a packet forwarding delay and prevents the predicted timeout when the device 160 performs a hard handover between the base stations 140 and 150. This exemplary method for preventing timeout includes starting a timer when the device 160 is attached to the target base station 150, and transmitting a duplicated ACK by the device 160 at the expiry of timer in order to prevent TCP of the fixed host 110 from operating in a slow start state. This exemplary embodiment relates to the operation of the device 160. A transmission layer of the fixed host 110 follows the operation of normal TCP.

Referring to FIG. 6A, it is supposed that the device 160 is detached from the serving base station 140 in response to a handover command and attached to the target base station 150. In step 610, the device 160 transmits a handover confirm, so that a handover is completed. However, if there is some danger the fixed host 110 may operate in a slow start state, the device 160 performs a procedure after step 620 in order to prevent such danger.

In step 620, the device 160 sets up the timer. The timer expiry time E may be defined as Equation 2.

E=t_{RTO}−D−τ Equation 2

In Equation 2, the value of E means the maximum timer expiry time such that, before timeout, the fixed host 110 can receive two or more duplicated ACKs transmitted from the device 160 after timer expiry. Therefore, in comparison with t_{RTO} of the fixed host 110, this time should be smaller by a time required for transmission of an ACK packet from the device 160 to the fixed host 110. In Equation 2, a retransmission timeout value of the device 160 may be used as t_{RTO}. The value of D means a time required for transmission of an ACK packet from the device 160 to the fixed host 110 and may use half of t_{sRTT} measured by the device. In order to adjust the sensitivity of process according to an exemplary implementation, a time reduction (i) may be used.

In step 630, the device 160 determines whether the next packet in order is received from the fixed host 110. If the next packet is received, the device 160 determines that there is no possibility of timeout of the fixed host 110, and stops the timer. The device 160 transmits a normal ACK corresponding to the received packet to the fixed host 110. On the contrary, if the next packet is not received, the device 160 proceeds to step 640 and determines whether the timer expires. If the timer has expired, the device 160 proceeds to step 650 and performs a slow start avoidance operation. If the timer has not expired, the device 160 repeats steps 630 and 640 until the timer expires or the next packet is received.

FIG. 6B is a flowchart illustrating a slow start avoidance step according to an exemplary embodiment of the present invention.

Referring to FIG. 6B, the device 160 transmits, to the fixed host 110, two (or more) duplicated ACKs having the same identifier (e.g., acknowledgement number field) as the final ACK transmitted from the device 160 to the fixed host 110 in step 652. Therefore, the fixed host 110 receives in total three ACKs (i.e., the final ACK previously transmitted and two ACKs newly transmitted) with the same identifier. If three or more duplicated ACKs are received before timeout, the fixed host 110 performs a fast retransmission operation, instead of a slow start operation, and operates in a fast recovery state. Here, it is supposed that the device 160 sends three duplicated ACKs to the fixed host 110 in order to perform fast retransmission more reliably. However, even though the serving base station 140 sends only two duplicated ACKs to the fixed host 110, the present invention may be realized. If the fixed host 110 performs fast retransmission and operates in a fast recovery state only when additionally receiving three or more ACKs with the same identifier as a previously received ACK, the serving base station 140 should send at least three duplicated ACKs to the fixed host 110 such that the fixed host 110 can perform fast retransmission.

In step 654, the device 160 is on standby for a given period. In step 656, the device 160 determines whether the next packet is received in good order from the fixed host 110. If so, the device 160 stops transmission of a duplicated ACK and instead transmits a normal ACK to the fixed host 110. The fixed host 110 that receives the normal ACK operates in a congestion avoidance state. On the contrary, if failing to receive the next packet from the fixed host 110, the device 160 proceeds to step 658 and transmits, to the fixed host 110, a duplicated ACK with the same identifier as the ACK packet finally transmitted from the device 160 to the fixed host 110. Until the next packet is received, the device 160 transmits a duplicated ACK to the fixed host 110 at regular intervals by repeating steps 654, 656 and 658. The fixed host 110 can transmit new packet in a fast recovery state.

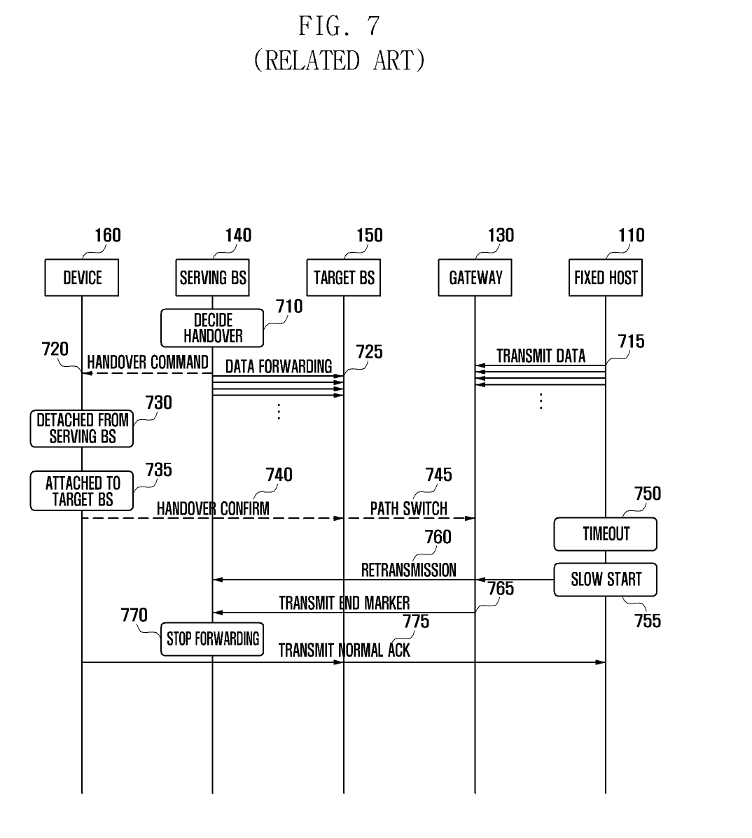

FIG. 7 is a flow diagram illustrating a handover process according to the related art.

Referring to FIG. 7, the serving base station 140 determines if a handover is necessary in step 710. For example, if the strength or quality of a signal of the serving base station 140 received by the device 160 is smaller than a given level, or if the strength or quality of a signal of the target base station 150 is greater by a given level than the strength or quality of a signal of the serving base station 140 received by the device 160, it may be determined that a handover should be performed. For example, the serving base station 140 may receive a report on signal quality of the target base station 150 from the device 160 periodically or by means of direct instructions. Depending on the received report, the serving base station 140 determines whether to perform a handover of the device 160 and which base station is the target of handover. Since the determination of handover is well known in the art, detailed descriptions will be avoided herein.

In step 715, the fixed host 110 transmits data for the device 160 to the gateway 130. Since a handover is not yet completed, the gateway 130 transmits the received data to the serving base station 140. Such data transmission may be performed concurrently with other steps.

In step 720, when a handover is determined to be performed, the serving base station 140 transmits a handover command message and necessary information for handover to the device 160. In step 725, the serving base station 140 forwards a packet for the device 160 to the target base station 150. This data forwarding in step 725 continues until the serving base station 140 recognizes the completion of the handover.

The device 160 is detached from the serving base station 140 in step 730 and attached to the target base station 150 in step 735. In step 740, the device 160 sends a handover confirm message to the target base station 150. In step 745, the target base station 150 that receives the handover confirm message notifies the gateway 130 that the path for the device 160 is changed. Therefore, the gateway 130 can switch path information indicating a path that leads to the device 160.

Due to delays caused by detachment in step 730 and attachment in step 735, the fixed host 110 is subject to timeout in step 750. In step 755, the fixed host 110 operates in a slow start state. As discussed above, in a slow start state, cwnd becomes one, so that the transmission rate may be considerably reduced. In step 760, through the gateway 130, the fixed host 110 retransmits a specific packet for which ACK is not received.

In step 765, the gateway 130 transmits an end marker indicating the completion of handover to the serving base station 140. In step 770, the serving base station 140 that receives the end marker stops data forwarding. In step 775, the device 160 receives data through the target base station 150 and transmits a normal ACK to the fixed host 110.

According to the exemplary process shown in FIG. 7, the transmission rate is considerably reduced since a slow start operation is performed.

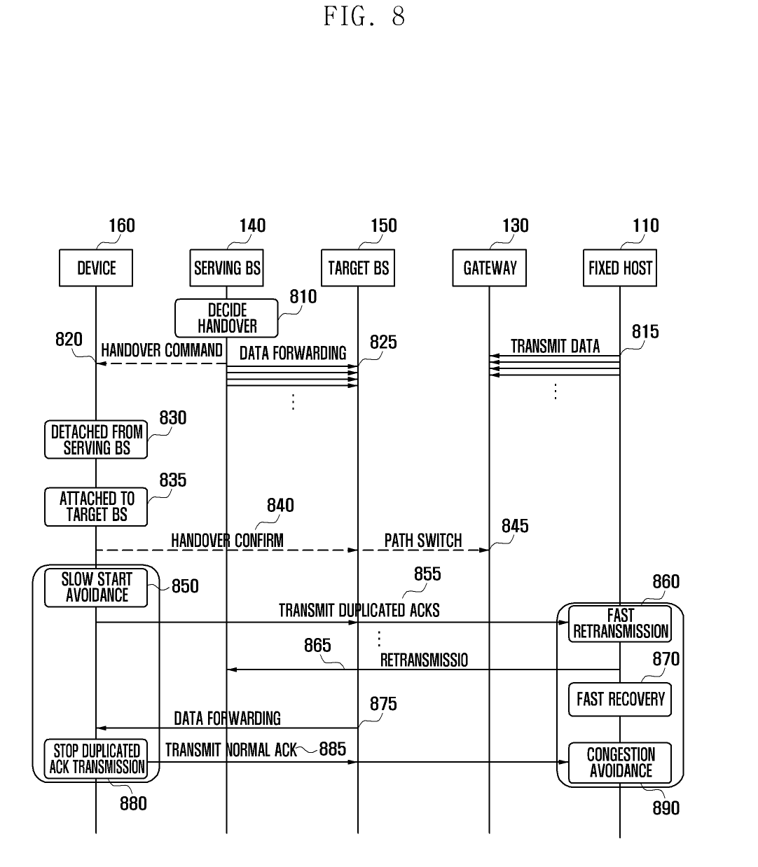

FIG. 8 is a flow diagram illustrating a communication process in accordance with an exemplary embodiment of the present invention.

Referring to FIG. 8, steps 810 to 845 correspond to the above-discussed steps 710 to 745, respectively, and the repetition of descriptions will be avoided hereinafter.

In step 850, the device 160 performs a slow start avoidance operation after the completion of handover. In step 855, the device 160 transmits, to the fixed host 110, two (or more) duplicated ACKs having the same identifier (e.g., acknowledgement number field) as the final ACK transmitted to the fixed host 110. Therefore, the fixed host 110 receives in total three ACKs (i.e., the final ACK previously transmitted and two ACKs newly transmitted) with the same identifier. In step 860, the fixed host 110 that receives three or more duplicated ACKs performs a fast retransmission operation. Additionally, the fixed host 110 sets up ssthresh and cwnd as follows: ssthresh=cwnd/2, cwnd=ssthresh+3. In step 865, the fixed host 110 retransmits data that corresponds to a relevant duplicated ACK. Thereafter, the device 160 periodically transmits a duplicated ACK to the fixed host 110, and in step 870 the fixed host 110 can transmit new data at a high transmission rate by operating in a fast recovery state.

In step 875, new data transmitted from the fixed host 110 is forwarded to the device 160 through the target base station 150. The device 160 that receives new data stops periodic transmission of a duplicated ACK in step 880 and transmits a normal ACK corresponding to the received new data to the fixed host 110 in step 885. In step 890, the fixed host 110 that receives a normal ACK operates in a congestion avoidance state.

Exemplary embodiments of the present invention are described herein with reference to flowchart illustrations of user interfaces, methods, and computer program products. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a non-transitory computer usable or computer-readable memory that can direct a computer or other programmable data processing apparatus to function in a particular manner, such that the instructions stored in the non-transitory computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “unit”, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

While this invention has been shown and described with reference to an exemplary embodiment thereof, it will be understood by those skilled in the art that various changes in form and details may be made therein without departing from the spirit and scope of the invention as defined by the appended claims and their equivalents.

What is claimed is:

1. A communication method of a serving base station, the method comprising:
determining if a handover of a device attached to the serving base station is required; and
if the handover is required, transmitting two or more duplicated acknowledgements (ACKs) to a fixed host wherein the two or more duplicated ACKs have the same identifier as a final ACK transmitted from the device to the fixed host.

2. The method of claim 1, wherein the transmitting of the two or more duplicated ACKs comprises:
estimating a round trip time (t_{RTT}) when the fixed host receives an ACK for a packet after transmitting the packet;
determining, using both the estimated round trip time and a given retransmission timeout (t_{RTO}), whether the transmission of the duplicated ACK is required; and
if the transmission of the duplicated ACK is required, transmitting the two or more duplicated ACKs to the fixed host.

3. The method of claim 2, wherein the transmission of the duplicated ACK is required when the estimated round trip time is greater than the given retransmission timeout.

4. The method of claim 3, wherein the estimating of the round trip time comprises:
extracting a smoothed round trip time (t_{sRTT}) of a packet transmitted from the fixed host to the device;
extracting a detached time when the device is disconnected due to the handover; and
estimating, using both the smoothed round trip time and the detached time, the round trip time.

5. The method of claim 4, wherein the estimating of the round trip time comprises:
estimating the round trip time from the sum of the smoothed round trip time and the detached time.

6. The method of claim 1, further comprising:
after the transmitting of the two or more duplicated ACKs, periodically transmitting one or more duplicated ACK to the fixed host until detecting that the device is attached to a target base station.

7. The method of claim 1, wherein the fixed host that receives the two or more duplicated ACKs operates in a fast retransmission state and operates in a fast recovery state.

8. The method of claim 1, further comprising:
forwarding a packet for the device to a target base station to which the device is attached after the handover.

9. The method of claim 1, wherein the transmitting of the two or more duplicated ACKs comprises:
transmitting at least three duplicated ACKs to the fixed host.

10. A communication method of a device, the method comprising:
attaching to a target base station according to handover; and
after the attaching to the target base station, transmitting two or more duplicated acknowledgements (ACKs) to a fixed host wherein the two or more duplicated ACKs have the same identifier as a final ACK transmitted from the device to the fixed host.

11. The method of claim 10, wherein the transmitting of the two or more duplicated ACKs comprises:
setting up a timer; and
transmitting the two or more duplicated ACKs to the fixed host when the timer is expired.

12. The method of claim 11, further comprising:
after the setting up of the timer, stopping the timer when the device receives a new packet.

13. The method of claim 12, wherein the setting up of the timer comprises:
extracting a given retransmission timeout (t_{RTO});
estimating an ACK transmission time required for the transmission of the ACK from the device to the fixed host; and
setting up a timer expiry time using the retransmission timeout and the ACK transmission required time.

14. The method of claim 13, wherein the ACK transmission required time is estimated as half of a smoothed round trip time (t_{sRTT}) of a packet transmitted from the fixed host to the device.

15. The method of claim 13, wherein the timer expiry time is obtained by subtracting both the ACK transmission required time and a given time reduction from the retransmission timeout.

16. The method of claim 13, wherein the retransmission timeout is extracted by using a retransmission timeout value of the device.

17. The method of claim 10, wherein the fixed host that receives the two or more duplicated ACKs operates in a fast retransmission state and operates in a fast recovery state.

18. The method of claim 11, further comprising:
after the transmitting of the two or more duplicated ACKs, periodically transmitting the duplicated ACK to the fixed host until the device receives a new packet.

19. The method of claim 10, wherein the transmitting of the two or more duplicated ACKs comprises:
transmitting at least three duplicated ACKs to the fixed host.
